(19) United States
(12) Patent Application Publication
(10) Pub. No.: US 2012/0241531 A1
(43) Pub. Date: Sep. 27, 2012

(54) Non-Pneumatic Irrigation System Tower Support Wheel

(76) Inventor: Michael Werner, Sterling, CO (US)

(21) Appl. No.: 13/053,438

(22) Filed: Mar. 22, 2011

(51) Int. Cl. A01G 25/06; B23P 6/00; B60C 11/03; B60C 25/00; B60B 21/06; B60B 27/00

(52) U.S. Cl. 239/1; 301/95.101; 152/209.12; 157/1.1; 29/894

(57) ABSTRACT

The present invention comprises a wheel assembly for use on a tower of an irrigation system. The wheel assembly comprises a generally cylindrical wheel having a hub, one or more spokes and a rim to which a plurality of non-pneumatic tire sections are mounted to encircle and effectively cover the circumferential outwardly facing surface of the rim. The tire segments are typically solid and comprised of a resilient polymeric material such as polyurethane.

### FIELD OF THE INVENTION

The present invention pertains generally to wheels for irrigation systems.

### BACKGROUND

Irrigation systems are used to irrigate farm land that is located in regions that do not regularly and reliably receive sufficient rainfall to dispense with supplemental watering. Typical irrigation systems comprise a series of spaced support towers that are connected at their top ends by booms or boom assemblies. The boom assemblies, which can extend 180 feet or so in length, carry the irrigation water to sprinkler heads that are distributed along their lengths. Between two and twenty booms (or spans) can be coupled together to irrigate a swath of land to nearly three quarter of a mile long. The entire structure travels either circumferentially about a pivot or linearly to irrigate large tracts. Accordingly, each tower includes two or more wheels to impart mobility and provide for the propulsion of the structure across the associated tract.

The majority of current irrigation systems use wheels with pneumatic tires. There are several issues related to these. First in the instance of a flat, the whole wheel may need to be transported across a large field, repaired and transported back to the irrigation tower. These wheels tend to be quite large and heavy. A tractor can be used to transport the wheel but driving the tractor across the field of growing crops will almost certainly destroy the crops that are in its path. A wheel can often be rolled to and from a site but it may require two people and consume a good number of the hours in a day.

As can be appreciated, the ground beneath the tires often becomes muddy. The tread of the tire can fill with mud and thereby lose its ability to gain traction over the ground. Excessive slippage can prevent the irrigation system from advancing properly preventing some areas from being water at all while other areas are over watered. Finally, pneumatic rubber tires tend to form deep ruts in the muddy ground over which they travel. These ruts can be as much as 6-12″ deep. When tractors drive over these ruts, such as during or after harvest especially after the ground has hardened, damage to the tractor in the form of cracked axles and/or flat tires can result.

As can be appreciated, an irrigation system wheel that does not easily become damaged; has good traction over muddy surfaces; does not cause excessive rutting to the ground over which it travels; and is easily repaired is desirable.

### BRIEF DESCRIPTION OF THE DRAWINGS

FIG. 1 is an isometric view of an irrigation system according to one embodiment of the present invention.

FIG. 2 is a side view of an irrigation system tower according to one embodiment of the present invention.

FIG. 3 is an isometric view of an irrigation system wheel primarily according to one embodiment of the present invention.

FIG. 4 is a side view of the irrigation system wheel according to one embodiment of the present invention.

FIG. 5 is an isometric view of a removable/replaceable tire section of an irrigation system wheel according to an embodiment of the present invention.

FIG. 6 is a side view of a removable/replaceable tire section of an irrigation system wheel according to an embodiment of the present invention.

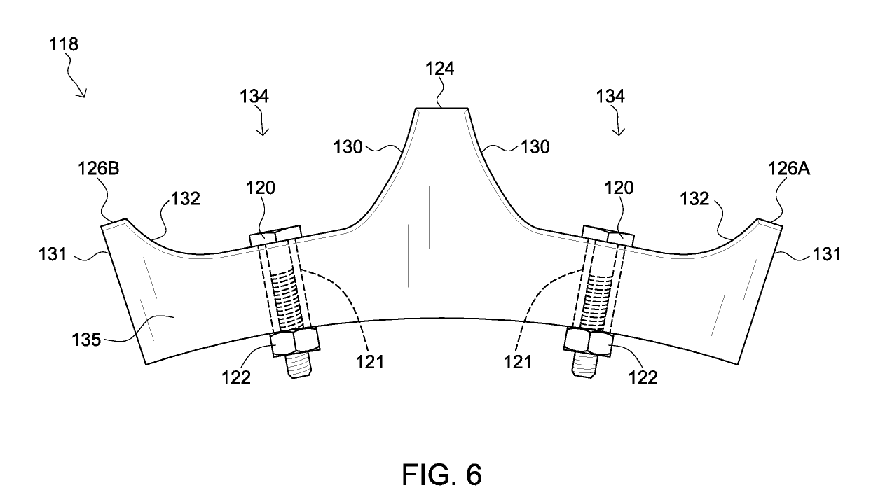

### DETAILED DESCRIPTION

Embodiments of the present invention comprise a wheel assembly for use on a tower of an irrigation system. The wheel assembly comprises a generally cylindrical wheel having a hub, one or more spokes and a rim to which a plurality of non-pneumatic tire sections are mounted to encircle and effectively cover the circumferential outwardly facing surface of the rim. The tire segments are typically solid and comprised of a resilient polymeric material such as polyurethane.

The foregoing design offers several advantages over prior art wheel assemblies that incorporate a pneumatic tire. Significantly, there is no traditional tire to be punctured reducing the risk that the wheel assembly will become damaged necessitating repair and replacement of a damaged tire. Further, in some embodiments, if a tire section becomes damaged, it can be individually removed and replaced. As is intuitively obvious, it is much easier to transport individual tire sections to tower in a planted field than it is to transport an entire tire with a diameter of nearly four feet.

The tread design of the tire sections in some embodiments is configured to minimize rutting while at the same time providing superior traction that permits the wheels to be drive a tower through muddy or water logged sections of a field without becoming stuck. Collectively, the tire sections form a tread pattern comprised of alternating lugs and channels that extend across the width of the tire section in the same direction as the wheel's axis of rotation. The heights of the lugs above the channel floor vary alternating between high and low heights.

One variation of the wheel assembly has undergone field testing. The wheel assembly has an outside diameter of about 44.5″ and a width of about 10.0″. The high lugs extend about 2 inches above the adjacent channel floors; whereas, the alternating low lugs extend only about 1 inch above the adjacent floors. The sidewalls of the lugs are tapered and radiused to avoid an abrupt transition with the channel floors. In operation the wheel assembly left no trench to only a minimal trench along its tracks; whereas, a trench of 6-8″ was formed using a prior art pneumatic tire. Further, the wheel assemblies were found to be significantly less likely to become stuck even in areas that had proven troublesome for wheel assemblies with pneumatic tires.

### Terminology

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, tense or any singular or plural variations of the defined word or phrase.

The term “or” as used in this specification and the appended claims is not meant to be exclusive rather the term is inclusive meaning “either or both”.

References in the specification to “one embodiment”, “an embodiment”, “a preferred embodiment”, “an alternative embodiment”, “a variation”, “one variation”, and similar phrases mean that a particular feature, structure, or characteristic described in connection with the embodiment is included in at least an embodiment of the invention. The appearances of phrases like “in one embodiment”, “in an embodiment”, or “in a variation” in various places in the specification are not necessarily all meant to refer to the same embodiment or variation.

Directional and/or relationary terms such as, but not limited to, left, right, nadir, apex, top, bottom, vertical, horizontal, back, front and lateral are relative to each other and are dependent on the specific orientation of an applicable element or article, and are used accordingly to aid in the description of the various embodiments and are not necessarily intended to be construed as limiting.

As applicable, the terms “about” or “generally” as used herein unless otherwise indicated means a margin of +−20%. Also, as applicable, the term “substantially” as used herein unless otherwise indicated means a margin of +−10%. It is to be appreciated that not all uses of the above terms are quantifiable such that the referenced ranges can be applied and as such where the indicated margins are not readily applicable, the foregoing terms have meanings attributable to them as would be understood by someone of ordinary skill in the art given the benefit of this disclosure.

As used herein, the term “rim” refers to a substantially cylindrical rigid structure upon which a tire or tire sections mount or are otherwise secured. An “outwardly facing surface” of the rim faces radially away from a center point or rotational axis of the rim; whereas, an “inwardly facing surface” faces toward the center point in the opposite direction.

As used herein the term “hub” refers to the center part of a wheel and typically includes a means for coupling to an associated structure that permits the wheel to rotate relative to the structure along an axis of rotation that passes through the hub.

As used herein the terms “spoke” and “spoke portion” refers to any physical structure that extends between a hub and a rim and facilitates the transfer of load between the hub and the rim.

As used herein the term “tire” refers to a covering for the outwardly facing surface of a rim that acts as an intermediary between the wheel and the ground surface over against which the wheel assembly turns. The term “tire section” as used herein refers to any piece or unit that is adapted to cover a fraction of the outwardly facing surface of the rim by itself or cover substantially the entire outwardly facing surface of the rim in combination with other “tire sections”.

As used herein the term “lug” refers to a projecting portion of a tire or tire section, that assists in providing traction when in use. When used herein in relation to a tire section, the term “lug” refers to each projecting portion extending outwardly of the tire section. When used in relation to a plurality of “tire sections” that encircle a rim as to collectively form a “tire”, the term “lug” may refer a combination of two abutting “lugs” located at the edges of the respective tire sections as to appear to comprise a single lug.

As used herein the term “channel” refers to a groove or flute on a tire or tire section bounded by bounded by at least two lugs.

As used herein the phrase “isosceles trapezoid” refers to a quadrilateral with a line of symmetry bisecting one pair of opposite sides excluding rectangles.

As used herein the phrase “right trapezoid” refers to is a trapezoid that has at least two right angles excluding rectangles.

As used herein the phrase “Irrigation tower” refers to any structure that extends vertically from near a ground surface and supports proximate a top end thereof at least one end of an irrigation boom assembly that spans between two adjacent towers. Typically, an irrigation tower is coupled to the ground by way of two or more wheel assemblies that in use permit the tower to travel across a field.

As used herein the phrase “Irrigation boom assembly” refers to a conduit that extends between associated irrigation towers and the associated structure required to support the conduit and facilitate the delivery of water to a field over which it is traversing. The irrigation boom assembly typically includes a plurality of sprinkler heads distributed over its length.

As used herein the phrase “Single pivot irrigation system” refers to an irrigation system comprising a plurality of towers and boom assemblies that extend outwardly of a central pivot location or central tower. Water is typically supplied from the central location to the boom assemblies. The entire system is typically adapted to travel in a circular arc about the center pivot watering a circular area or partially circular area therebeneath.

### An Embodiment of a Irrigation System

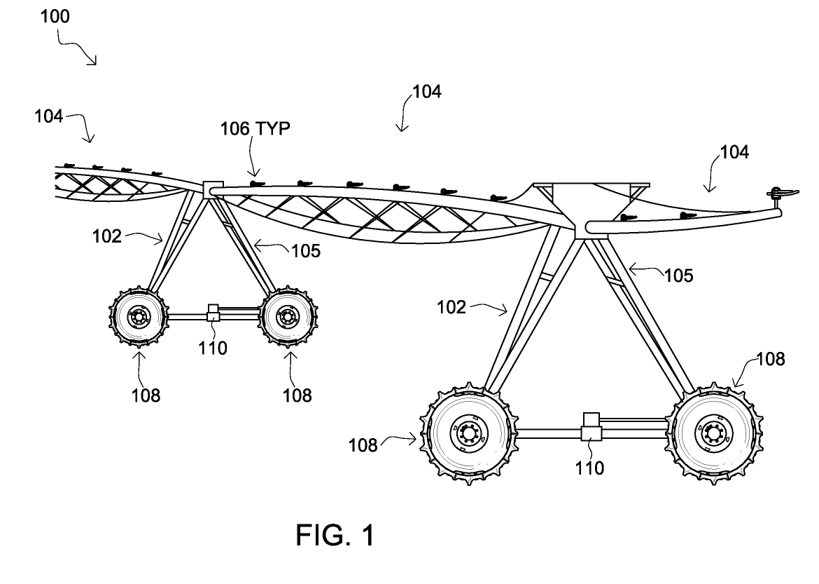

FIGS. 1 & 2 are partial sections of an automated irrigation system 100 as is typically used to irrigate crops in arid parts of the world or those regions where regular precipitation is not reliable. FIG. 1 specifically illustrates a pair of towers 102 with a boom assembly 104 with extending between the towers. Various types of irrigation systems are well known in the art: some travel linearly across a field; others known as single pivot systems pivot in a circular motion about a central location; and finally, there are others that can be programmed/configured to travel in a manner customized for the configuration of a particular plot of land. The boom assembly, which typically spans about 180 feet, serves to carry water to downstream boom assemblies and deliver water to the ground below the boom assembly by way of sprinkler heads 106 distributed along its length. Depending on the size of field that is being irrigated, an irrigation system may include 2 to 20 boom assemblies that aligned can span nearly three quarters of a mile.

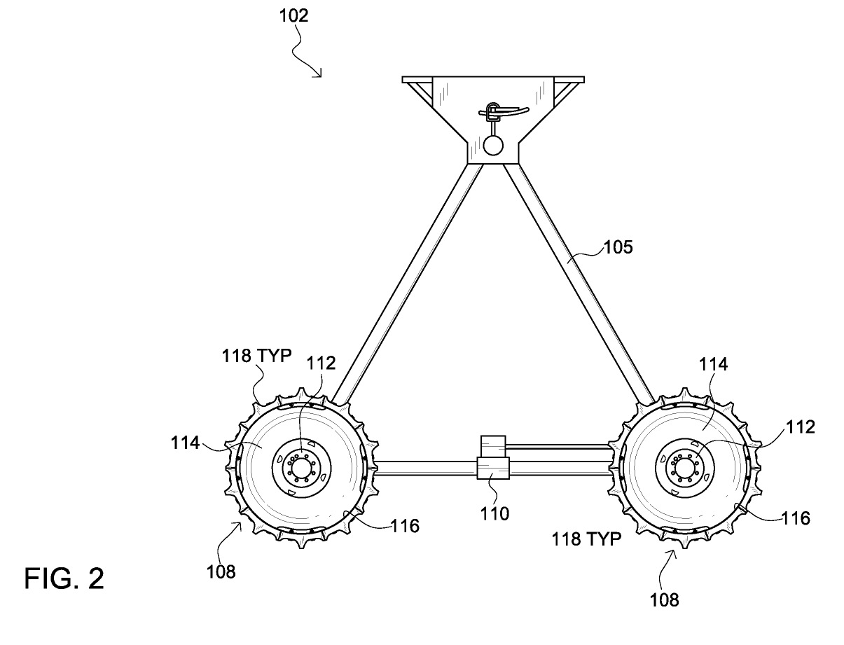

FIG. 2 provides a side view of a typical tower 102. A tower includes framework 105 for elevating an end of one or two boom assemblies above the ground and securing the boom assemblies 104 thereto. Two to four wheel assemblies 108 are typically provided at the base of the tower to facilitate its traverse across the underlying ground. The embodiment illustrated herein utilizes wheel assemblies with non-pneumatic sectioned tires as are described in detail below. At least one of the wheels on each tower is driven by a hydraulic or electric motor 110 located on the tower permitting the tower in concert with other towers to move along a desired course. As necessary, electricity and/or hydraulic fluid is carried through the appropriate conduit from a central location typically along the boom assemblies.

### An Embodiment of an Irrigation Wheel Assembly

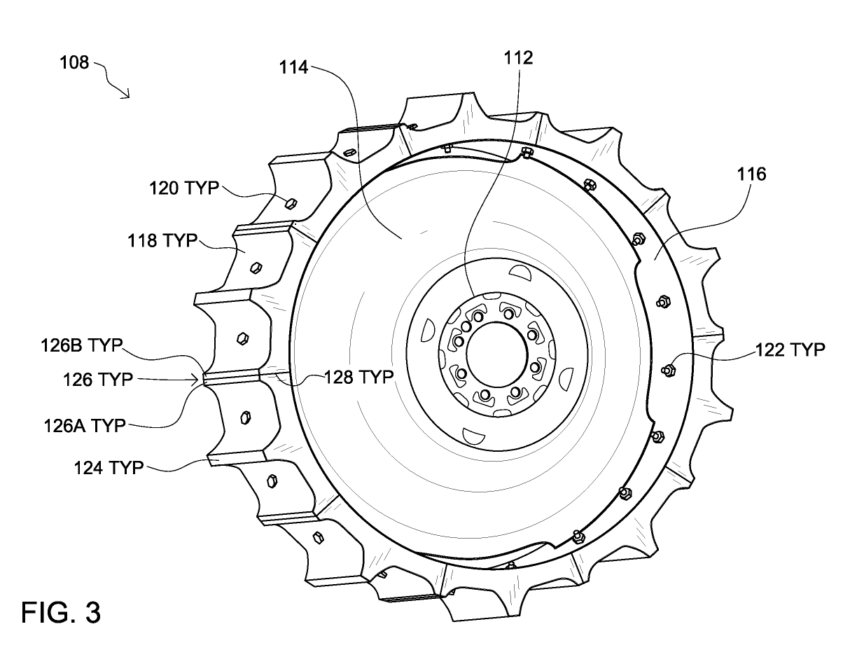

An irrigation wheel assembly 108 according to embodiments of the present invention is best illustrated in FIGS. 3 & 4. Starting at the center of the wheel assembly, a hub 112 is provided. Through the hub, the wheel assembly is coupled with an axle of the irrigation system tower permitting the wheel to rotate about an axis of rotation that is typically coincident with the longitudinal axis of the axle. On the hub as illustrated, a plurality of bolt holes are provided to receive axles bolts therein to secure the wheel assembly to the axle although other means of connection can be used as well. In a typical wheel the hub is comprised of formed steel plate although it can be made from any suitable material including but not limited to other metals and reinforced plastics.

One or more spokes 114 extend radially outwardly from the hub 112. As shown, the single illustrated spoke comprises an annular flange that is integrally formed with a portion of the hub through stamping or other forming methods. Although not readily apparent from the Figures, in some variations an additional steel plate is welded to the integrally formed portion of the hub to stiffen and reinforce it to better handle the loading applied when the axle bolts are tightened. In some variations, the hub may be distinct and separate from the spoke(s) and coupled to the spoke(s) through mechanical means (e.g. rivets or threaded fasteners), adhesive bonding and brazing. As can be appreciated the size, shape, number and configuration of the spoke(s) as well as the materials from which they are comprised can vary in other wheel configurations.

The spoke 114 is attached to an inwardly facing surface of a cylindrical rim 116 at the spoke's periphery. As shown the rim comprises a thin walled steel tube having the aforementioned inwardly facing surface and an opposing radially outwardly facing surface. Wherein the spoke(s) and rim both comprise steel, they can be joined/attached by welding, although the rim and spoke(s) can be coupled in any suitable manner including mechanical means, adhesive bonding and brazing. In some variations the entire wheel comprising the hub, spoke(s) and rim can be integrally formed, such as a cast or wrought aluminum wheel or a molded reinforced plastic wheel. As applicable, the wheel may be painted, galvanized or otherwise coated for corrosion protection.

The size of the wheel will vary depending on the specific configuration of the associated irrigation system and more specifically the configuration of the irrigation system tower assemblies; however, one variation of the wheel assembly uses a rim 116 having an outside diameter of about 36″ and a width of about 10″.

To complete the wheel assembly 108 as illustrated a plurality of tire sections 118 are mounted to the outwardly facing surface of the rim 116. The tire sections are typically comprised of a solid semi-elastomeric polymer, such as formulations of polyurethane, and in combination effectively encircle and cover the outwardly facing surface of the rim. As shown, ten tire sections cover the rim each having a circumfrencial length of about 36 degrees but variations with more or fewer sections are contemplated. Each segment is secured to the rim by two bolts 120 and associated threaded nuts 122. In some variations the threaded nuts are welded to the inwardly facing surface of the rim; whereas, in other variations they are separate and removable. The bolts are passed through corresponding bolt holes in both the associated tire segments and the rim. The lateral or widthwise extending edges of each segment abut lateral extending edges of adjacent segments. Each segment can typically be removed from the remainder of the wheel assembly without removing any other tire segment. The construction and configuration of an exemplary tire segment as used in certain embodiments and variations is described in detail below.

### An Embodiment of a Tire Section

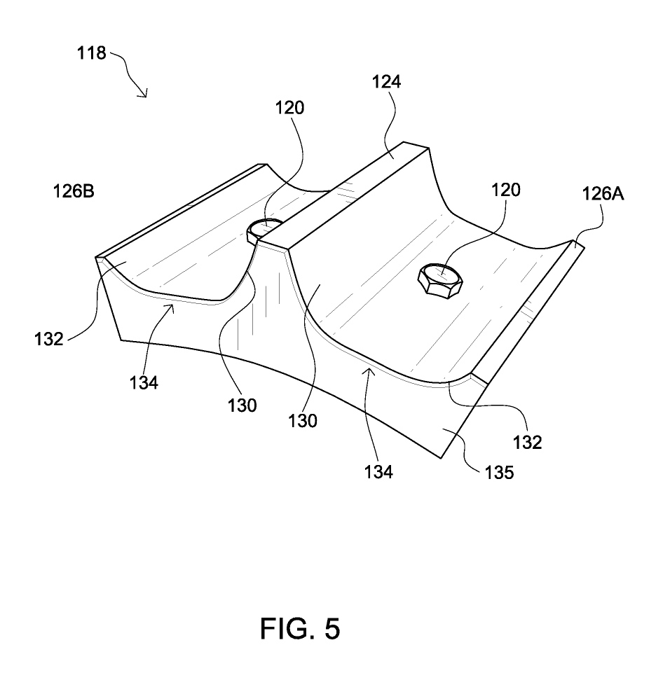

A tire section according to embodiments of the present invention is best illustrated in FIGS. 5 & 6. As mentioned above, the illustrated tire section is comprised of a semi-elastomeric polymer, such as polyurethane and is substantially solid. The section is typically molded by injecting liquid reactive precursors into a mold and permitting the section to harden as the components react and cross link. In one variation, the cured polyurethane has a Shore A hardness of about 65-95. Variations are contemplated that have other hardnesses and differing levels of resiliency. Further variations are contemplated that are made from other materials including other plastics and rubbers, as well as, metals. While the illustrated embodiment is substantially solid, variations may include cavities to reduce the weight of the final product and give the tire section more flexibility.

As shown, the tire section embodiment 118 comprises a body portion 135 that includes an inwardly facing concave surface having a radius of curvature similar to the radius of curvature of the outwardly facing surface of an associated rim 116 to which is it designed to mate. As indicated above, the tire section illustrated has a circumferential length of 36 degrees and as such 10 sections are required to encircle the outwardly facing surface of the rim. The radial thickness of the body portion 135 can vary depending on the particular design of the tire section, the material of which the tire section is constructed and the size of the rim 116 to which it is to be attached. In the polyurethane variation designed for a wheel having a 36″ rim a thickness of about 1.70″ has been found to be suitable.

In the illustrated embodiment, three lugs 124, 126A & 126B extend radially outwardly from the body portion 135. A first lug 124 is provided proximate the center of the circumferential length of the body section 135. The first lug has a cross sectional shape generally resembling an isosceles trapezoid bisected along a radial line that extends through the axis of rotation of the associated wheel assembly 108 when the section 118 is mounted thereupon. The first lug tapers as it extends outwardly from the base with its sides 130 being partially radiused and/or arcuate for a smooth not abrupt transition into the outwardly facing surface of the body portion. In the embodiment configured for a wheel having a 36″ rim, the first lug rises about 2.0-2.5″ radially outwardly of the outwardly facing surface of the body portion.

The second and third lugs 126A&B are located at the left and right widthwise-extending edges of the tire section 118 respectively. Each of these lugs has a cross section generally resembling a right trapezoid with a radially extending side 131, which also forms one of the edges of the tire section, and an opposing tapered side 132. As with the sides of the first lug 124, the tapered sides 132 of the second and third lugs are partially radiused and/or arcuate for a smooth not abrupt transition into the outwardly facing surface of the body portion. Typically, the radial height of the second and third lugs is less than the radial height of the first lug. In the embodiment configured for a wheel having a 36″ rim, the second and third lugs rise about 1.0-1.3″ radially outwardly of the outwardly facing surface of the body portion.

The sides 130 of the first lug and the tapered side 132 of the second and third lugs in combination with the outwardly facing surface of the tire section's body portion 134 act to form a pair of widthwise-extending outwardly-facing channels 134. The first channel is defined by the sides of the first and second lugs 124 & 126A and the second channel is defined by the sides of the first and third lugs 124 & 126B. The first lug rises between the first and second channels separating them from each other. In the embodiment configured for a wheel having a 36″ rim, the width of the channel from the top edge of the associated side of the first lug to the top edge of the tapered side of the associated second or third lug is about 6 inches.

Proximate a center location of each channel 134 a bore hole 121 that extends radially is provided through the body portion 121 of the tire section. The bore holes correspond with bolt holes provided in the rim 116 and are adapted to receive bolts 120 therethrough to secure the tire section 118 to the rim. The number, location and size of the holes can vary depending on the particular configuration, material and size of the associated tire section. In the embodiment configured for a wheel having a 36″ rim, the tire section bore holes are about 0.875″ in diameter and the associated bolts are about 0.75″ in diameter.

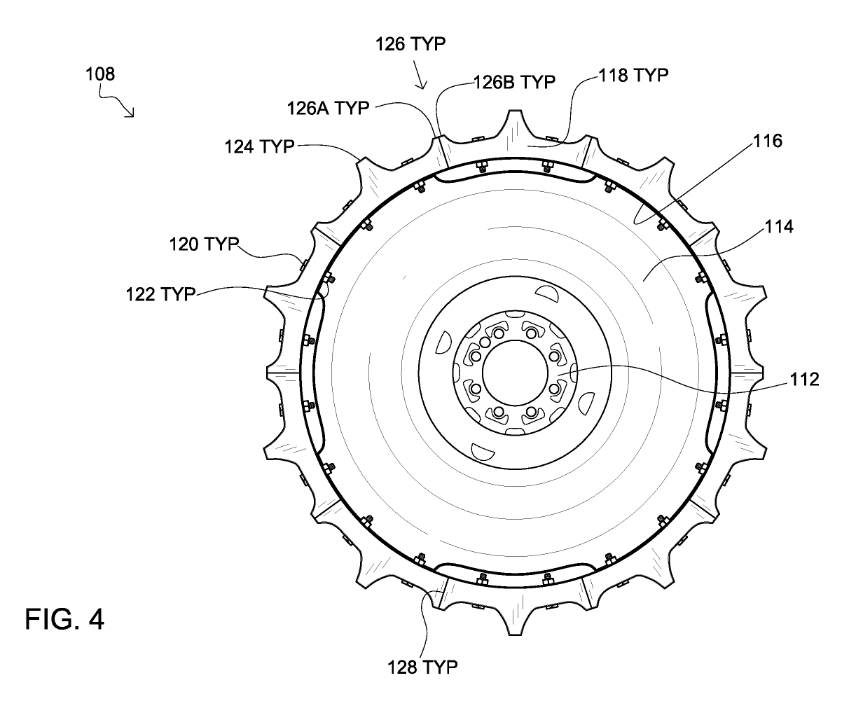

The construction of the wheel assembly 108 and the associated tire sections 118 permits a user to install and remove each tire section independently of the others. However, when all tire sections are secured around the outwardly facing surface of the rim, they effectively encircle the rim creating a complete tire. As can best be seen in FIG. 4, the widthwise extending edges of each section abut a widthwise extending edge of another adjacent section such that the second lug of one section abuts the third lug of an adjacent section together creating the appearance of a single isosceles lug of a lower radial height than the first lug. Accordingly, the tread surface of the assembled tire assembly appears to alternate between right isosceles lugs having higher and lower radial heights.

Given the ability to independently remove and install a tire section without substantially disturbing the other tire sections in a wheel assembly, replacement of a tire section 118 that has become damages is extremely easy and simple. To replace a tire section in the field, a person first transports a replacement section to the irrigation tower 102 where the wheel assembly 108 is located. Unlike when transporting an entire wheel, a single person can carry a section across a planted and growing field of crops without much difficulty. The use of a tractor that potentially will destroy crops as it rolls over them to transport the section is unnecessary.

Before replacing a tire section 118, it must be removed from the wheel assembly 108. Typically, this can be accomplished by merely loosening and removing the associated bolts 120 from the rim 116 and pulling the tire section radially outwardly. Because the edges of each tire section abut adjacent tire sections, there may be some stiction between adjacent sections that must be overcome to remove the desired section. In some circumstances, tapping the section with a mallet or hammer may be all that is necessary. In other circumstances, it may be desirable to loosening the bolts holding the adjacent tire sections to introduce a small amount of play that will permit removal of the desired section.

Once the tire section to be replaced is removed, the new section need only be slid into its place; and the bolts inserted through the new section and the rim and tightened in place. The removed section can then be carried from the field and be properly disposed.

### Other Variations and Embodiments

The various preferred embodiments and variations thereof illustrated in the accompanying figures and/or described above are merely exemplary and are not meant to limit the scope of the invention. It is to be appreciated that numerous variations to the invention have been contemplated as would be obvious to one of ordinary skill in the art with the benefit of this disclosure. For instance, the lug and tread design on the various sections can vary. The manner in which each section is attached to the wheel can also vary with, for example, clips or straps being used in place of bolts and nuts. In some variations, adjacent sections might more affirmatively mate and interlock with each other.

1. An irrigation tower wheel assembly, the wheel assembly comprising:
a generally cylindrical rim, the rim having a circumferential outwardly facing surface and an inwardly facing surface;
a hub portion configured to mount to an axle assembly of an irrigation tower, the hub portion being centered about an axis of rotation of the rim;
one or more spoke portions spanning between the hub portion and the rim portion;
a plurality of tire sections, each tire section abutting two other tire sections to collectively encircle the rim and generally cover the outwardly facing surface of the rim, each tire section being comprised of a resilient polymeric material and being removably secured to the rim.

2. The wheel assembly of claim 1, wherein the one or more spoke portions comprise a single radially extending flange.

3. The wheel assembly of claim 2 wherein the hub is integrally formed with the flange and the flange is welded to the rim.

4. The wheel assembly of claim 1, wherein the plurality of tire sections comprises ten tire sections.

5. The wheel assembly of claim 1, wherein the polymeric material comprises polyurethane.

6. The wheel assembly of claim 1, wherein each tire section comprises a plurality of lugs that extend radially outwardly from a remainder of the tire section and extend across the width of the tire section in the same direction as the axis of rotation.

7. The wheel assembly of claim 6, wherein at least one of the lugs on each tire section has a cross section generally resembling an isosceles trapazoid.

8. The wheel assembly of claim 6, wherein each tire section comprises:
three lugs, a first lug having a cross section generally resembling an isosceles trapazoid and being generally centered along a circumferential length of the tire section, and second and third lugs being located at the left and right widthwise extending edges of the section respectively and each having a cross section generally resembling a right trapezoid;
a pair of channels that extend across the width of the tire section in the same direction as the axis of rotation, the first channel being defined by sides of the first and second lugs, the second channel being defined by sides of the first and third lugs, the first and second channels being intervened by the first lug.

9. The wheel assembly of claim 8, wherein the sides of the respective lugs defining the channels are at least partially arcuate.

10. The wheel assembly of claim 8, wherein (i) the rim has a diameter of about 36 inches, (ii) the second and third lugs extend about one inch radially outwardly of a floor of the respective channels, and (iii) the first lug extends about two inches radially outwardly of the floor of the respective channels.

11. The wheel assembly of claim 1 wherein two or more radially extending bore holes are provided in each tire section and corresponding bore holes are provided at spaced locations circumferentially along the rim and wherein the wheel assembly further includes a plurality of threaded fasteners, each fastener passing through a bore hole in a tire section and a corresponding bore hole in the rim removably securing the tire sections to the rim.

12. An irrigation system having: (i) a plurality of towers wherein each tower includes two or more of the wheel assemblies of claim 1, each tower being spaced from the others; (ii) one or more irrigation boom assemblies spanning between each pair of towers; and (iii) a plurality of sprinkler heads distributed along each boom assembly.

13. The irrigation system of claim 12, wherein the irrigation system is a single pivot irrigation system.

14. A method of making the irrigation wheel of claim 1, the method comprising:
providing the generally cylindrical rim;
providing the hub portion and one or more spoke portions;
providing the plurality of tire sections;
joining the rim portion to the one or more spoke portions; and
securing the plurality of tire sections to the cylindrical rim.

15. A method of irrigating a field using the irrigation system of claim 13, the method comprising:
providing a source of irrigation fluid to the irrigation system;
pumping the fluid through the one or more boom assemblies and out of the plurality of sprinkler heads; and
advancing the plurality of towers and the associated boom assemblies about center pivot location along in an arcuate direction.

16. A method of repairing the irrigation wheel assembly of claim 1 while the wheel is installed attached to an irrigation tower of an irrigation system, the method comprising:
transporting one or more replacement tire sections to the irrigation wheel assembly, the irrigation wheel assembly being secured to an irrigation tower of an irrigation system;
removing one or more damaged or worn tire section of the plurality of tire sections from the wheel assembly; and
securing the one or more replacement tire sections to the cylindrical rim where the damaged or worn tire sections have been removed.

17. The method of claim 16 wherein said transporting one or more replacement tire sections to the irrigation wheel assembly comprises a person carrying the tire section and walking across a field of crops to the location of the irrigation wheel assembly.

18. A tire segment for use with an irrigation system wheel, the tire segment being substantially comprised of a polymeric material and including:
a body portion having inwardly facing concave surface and a radially extending thickness;
three lugs extending outwardly from the body portion, a first lug having a cross section generally resembling an isosceles trapazoid and being generally centered along a circumferential length of the tire section, and second and third lugs being located at the left and right widthwise extending edges of the section respectively and each having a cross section generally resembling a right trapezoid; and
a pair of outwardly facing channels that extend across the width of the tire section in the same direction as the longitudinal axis, the first channel being defined by sides of the first and second lugs and an outer surface of the body portion, the second channel being defined by sides of the first and third lugs and the outer surface of the body portion, the first and second channels being intervened by the first lug.

19. The tire segment of claim 18 wherein (i) the second and third lugs extend about one inch radially outwardly of a floor of the respective channels, (ii) the first lug extends about two inches radially outwardly of a floor of the respective channels and (iii) the segment further includes two bore holes extending from the inwardly facing concave surface through the body portion to the outer surface of the body section.

20. The tire segment of claim 18 wherein the polymeric material comprises polyurethane and has a shore A hardness of between about 65 and 95.
